(19) United States
(12) Patent Application Publication
(10) Pub. No.: US 2012/0082120 A1
(43) Pub. Date: Apr. 5, 2012

(54) METHOD AND APPARATUS FOR TRANSMITTING AN UPLINK CONTROL CHANNEL IN A WIRELESS COMMUNICATION SYSTEM

(76) Inventors: Jin Young Chun, Gyeongki-do (KR); Su Nam Kim, Gyeongki-do (KR); Bin Chul Ihm, Gyeongki-do (KR)

(21) Appl. No.: 13/322,426

(22) PCT Filed: May 28, 2010
(86) PCT No.: PCT/KR2010/003411

§ 371 Date: Nov. 23, 2011

Related U.S. Application Data
(60) Provisional application No. 61/181,673, filed on May 28, 2009.

(30) Foreign Application Priority Data
May 28, 2010 (KR) 10-2010-0050176

(51) Int. Cl. H04W 72/04

(52) U.S. Cl. 370/329

(57) ABSTRACT

The invention relates to a method and apparatus for transmitting an uplink control channel in a wireless communication system. User equipment generates bandwidth request preambles, maps the bandwidth request preambles to a bandwidth request channel (BRCH), and transmits the BRCH. The bandwidth request preambles may include ranging sequences for uplink synchronization.

### CROSS-REFERENCE TO RELATED APPLICATIONS

This application claims the benefit of priority of U.S. Provisional application No. 61/181,673 filed on May 28, 2009, and Korean Patent application No. 10-2010-0050176 filed on May 28, 2010, all of which are incorporated by reference in their entirety herein.

### BACKGROUND OF THE INVENTION

1. Field of the Invention

The present invention relates to wireless communication and, more specifically, to a method and apparatus for transmitting an uplink control channel in a wireless communication system.

2. Related Art

The institute of electrical and electronics engineers (IEEE) 802.16e standard was adopted in 2007 as a sixth standard for international mobile telecommunication (IMT)-2000 in the name of ‘WMAN-OFDMA TDD’ by the ITU-radio communication sector (ITU-R) which is one of sectors of the international telecommunication union (ITU). An IMT-advanced system has been prepared by the ITU-R as a next generation (i.e., 4^{th} generation) mobile communication standard following the IMT-2000. It was determined by the IEEE 802.16 working group (WG) to conduct the 802.16m project for the purpose of creating an amendment standard of the existing IEEE 802.16e as a standard for the IMT-advanced system. As can be seen in the purpose above, the 802.16m standard has two aspects, that is, continuity from the past (i.e., the amendment of the existing 802.16e standard) and continuity to the future (i.e., the standard for the next generation IMT-advanced system). Therefore, the 802.16m standard needs to satisfy all requirements for the IMT-advanced system while maintaining compatibility with a mobile WiMAX system conforming to the 802.16e standard.

Effective transmission/reception methods and utilizations have been proposed for a broadband wireless communication system to maximize efficiency of radio resources. An orthogonal frequency division multiplexing (OFDM) system capable of reducing inter-symbol interference (ISI) with a low complexity is taken into consideration as one of next generation wireless communication systems. In the OFDM, a serially input data symbol is converted into N parallel data symbols, and is then transmitted by being carried on each of separated N subcarriers. The subcarriers maintain orthogonality in a frequency dimension. Each orthogonal channel experiences mutually independent frequency selective fading, and an interval of a transmitted symbol is increased, thereby minimizing inter-symbol interference.

When a system uses the OFDM as a modulation scheme, orthogonal frequency division multiple access (OFDMA) is a multiple access scheme in which multiple access is achieved by independently providing some of available subcarriers to a plurality of users. In the OFDMA, frequency resources (i.e., subcarriers) are provided to the respective users, and the respective frequency resources do not overlap with one another in general since they are independently provided to the plurality of users. Consequently, the frequency resources are allocated to the respective users in a mutually exclusive manner. In an OFDMA system, frequency diversity for multiple users can be obtained by using frequency selective scheduling, and subcarriers can be allocated variously according to a permutation rule for the subcarriers. In addition, a spatial multiplexing scheme using multiple antennas can be used to increase efficiency of a spatial domain.

Femto base station technology may be applied to an 802.16m system, and active research has recently been done on the femto base station technology. A femto base station refers to an ultra-small size mobile communication base station used in rooms, such as homes and offices. A femto base station is used as a similar meaning to a pico cell. The femto base station is being used as a meaning having a more advanced function than the pico cell. In general, the femto base station has a low transmit power and provides access to a subscriber group consisting of subscribers or access providers. The femto base station is connected to an IP network provided at a home or an office, and it accesses the core network of a mobile communication system over the IP network and provides mobile communication service. That is, the femto base station is connected to the core network of a mobile communication system through broadband connection, such as a digital subscriber line (DSL). Furthermore, the femto base stations can communicate with each other by exchanging control messages through a macro base station and an air-interface overlaid with the femto base station. A user of a mobile communication system may be provided with service through the existing macro base station outdoors and may be provided with service through the femto base station indoors.

The femto base station can improve the indoor coverage of a mobile communication system by supplementing a point that the service of the existing macro base station is weakened within a building and may provide a high quality of voice service and data service because it can provide service to only a specific user. Furthermore, the femto base station can increase the efficiency of the next-generation cellular system using a high frequency band by reducing the size of a cell, and it is advantageous when increasing the number of times of frequency reuse because several small-sized cells can be used. In addition, the femto base station can provide new service that is not provided by a macro base station, accelerates Fixed-Mobile Convergence (FMC) with the spread of the femto base stations, and can reduce industry-based costs.

A control channel may be used to transmit various types of control signals for communication between a base station and a mobile station. An uplink control channel may include a fast feedback channel (FFBCH), a hybrid automatic repeat request (HARQ) feedback channel (HFBCH), a ranging channel, a bandwidth request channel (BRCH), and so on. Meanwhile, in a wireless communication system using a cell having a small coverage, such as a femto cell or a pico cell, the uplink control channel may be differently configured using characteristic that the coverage is small.

### SUMMARY OF THE INVENTION

The present invention provides a method and apparatus for transmitting an uplink control channel in a wireless communication system.

In an aspect, a method for transmitting an uplink control channel in a wireless communication system is provided. The method includes generating bandwidth request preambles, mapping the bandwidth request preambles to a bandwidth request channel (BRCH), and transmitting the BRCH, wherein the bandwidth request preambles comprise a ranging sequence for uplink synchronization. The bandwidth request preambles may further include a bandwidth request sequence for an allocation of uplink resources. The bandwidth request sequence may be divided into a 3-step bandwidth request sequence and a 5-step bandwidth request sequence. The 5-step bandwidth request sequence may be included in the ranging sequence. The BRCH may comprise 3 distributed tiles, and each of the tiles may comprise 6 subcarriers and 6 orthogonal frequency division multiplexing (OFDM) symbols. The bandwidth request preambles may be mapped to 4 subcarriers and 6 OFDM symbols. The method may further include generating a quick access message, and mapping the quick access message to the BRCH. The quick access message may be mapped to 2 contiguous subcarriers and 6 OFDM symbols. The method may further include receiving an uplink (UL) grant for allocating UL resources according to the quick access message from a base station, and performing UL transmission using the allocated UL resources. The quick access message may comprise a station identifier (STID) used for a base station to identify a mobile station during a network entry. The method may further include receiving, from a base station, a bandwidth request message grant for allocating resources on which a bandwidth request message will be transmitted according to the bandwidth request preambles, transmitting the bandwidth request message to the base station, receiving an UL grant for allocating UL resources according to the bandwidth request message, and performing UL transmission using the allocated UL resources.

In another aspect, an apparatus for transmitting an uplink control channel in a wireless communication system is provided. The apparatus includes a radio frequency (RF) unit configured for transmitting a bandwidth request channel (BRCH), and a processor, coupled to the RF unit, and configured for generating bandwidth request preambles, and mapping the bandwidth request preambles to the BRCH, and wherein the bandwidth request preambles are divided into a bandwidth request sequence for an allocation of UL resources and a ranging sequence for uplink synchronization. The BRCH may comprise 3 distributed tiles, and each of the tiles may comprise 6 subcarriers and 6 orthogonal frequency division multiplexing (OFDM) symbols. The bandwidth request preambles may be mapped to 4 subcarriers and 6 OFDM symbols. The bandwidth request sequence may be divided into a 3-step bandwidth request sequence and a 5-step bandwidth request sequence according to a bandwidth request process.

Signaling overhead can be reduced by using resources, allocated to a bandwidth request channel (BRCH), for purposes of a ranging channel.

### BRIEF DESCRIPTION OF THE DRAWINGS

FIG. 1 shows a wireless communication system.

FIG. 2 shows an example of a frame structure.

FIG. 4 is an example of the 3-step bandwidth request process.

FIG. 5 is an example of the 5-step bandwidth request process.

FIG. 6 shows an example of UL resources used in a BRCH.

FIG. 7 is an embodiment of a proposed method for transmitting an uplink control channel.

FIG. 8 is a block diagram showing of an MS in which the embodiments of the present invention are implemented.

### DESCRIPTION OF EXEMPLARY EMBODIMENTS

A technology below can be used in a variety of wireless communication systems, such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented using radio technology, such as universal terrestrial radio access (UTRA) or CDMA2000. TDMA can be implemented using radio technology, such as global system for mobile communications (GSM)/general packet radio service (GPRS)/enhanced data rates for GSM evolution (EDGE). OFDMA can be implemented using radio technology, such as IEEE 802.11 (Wi-Fi), IEEE 802.16 (WiMAX), IEEE 802-20, or Evolved UTRA (E-UTRA). IEEE 802.16m is the evolution of IEEE 802.16e, and it provides a backward compatibility with an IEEE 802.16e-based system. UTRA is part of a universal mobile telecommunications system (UMTS). 3rd generation partnership project (3GPP) long term evolution (LTE) is part of evolved UMTS (E-UMTS) using evolved-UMTS terrestrial radio access (E-UTRA), and it adopts OFDMA in downlink (DL) and SC-FDMA in uplink (UL). LTE-A (advanced) is the evolution of 3GPP LTE.

IEEE 802.16m is chiefly described as an example in order to clarify the description, but the technical spirit of the present invention is not limited to IEEE 802.16m.

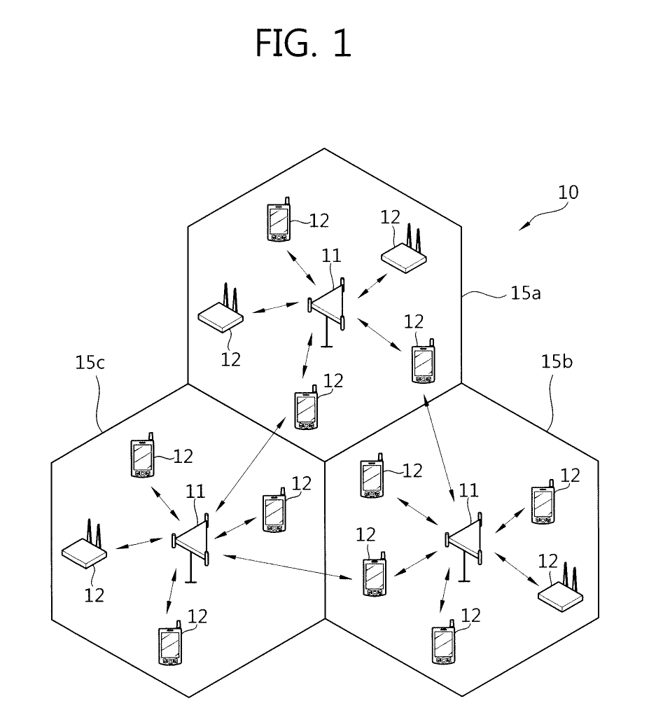

FIG. 1 shows a wireless communication system.

Referring to FIG. 1, the wireless communication system 10 includes one or more Base Stations (BSs) 11. The BSs 11 provide communication services to respective geographical areas (in general called ‘cells’) 15a, 15b, and 15c. Each of the cells can be divided into a number of areas (called ‘sectors’). A User Equipment (UE) 12 can be fixed or mobile and may be referred to as another terminology, such as a Mobile Station (MS), a Mobile Terminal (MT), a User Terminal (UT), a Subscriber Station (SS), a wireless device, a Personal Digital Assistant (PDA), a wireless modem, or a handheld device. In general, the BS 11 refers to a fixed station that communicates with the UEs 12, and it may be referred to as another terminology, such as an evolved-NodeB (eNB), a Base Transceiver System (BTS), or an access point.

The UE belongs to one cell. A cell to which a UE belongs is called a serving cell. A BS providing the serving cell with communication services is called a serving BS. A wireless communication system is a cellular system, and so it includes other cells neighboring a serving cell. Other cells neighboring the serving cell are called neighbor cells. A BS providing the neighbor cells with communication services is called as a neighbor BS. The serving cell and the neighbor cells are relatively determined on the basis of a UE.

This technology can be used in the downlink (DL) or the uplink (UL). In general, DL refers to communication from the BS 11 to the UE 12, and UL refers to communication from the UE 12 to the BS 11. In the DL, a transmitter may be part of the BS 11 and a receiver may be part of the UE 12. In the UL, a transmitter may be part of the UE 12 and a receiver may be part of the BS 11.

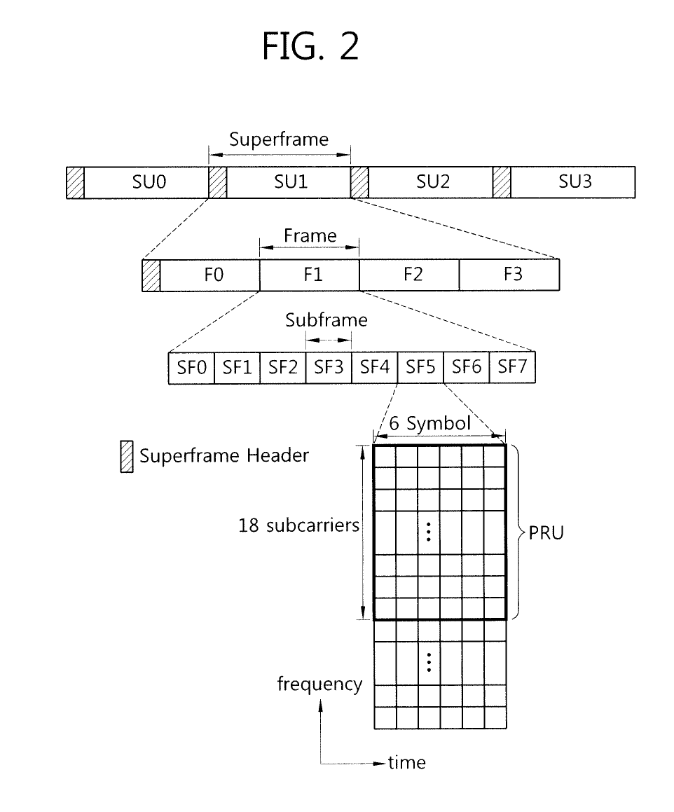

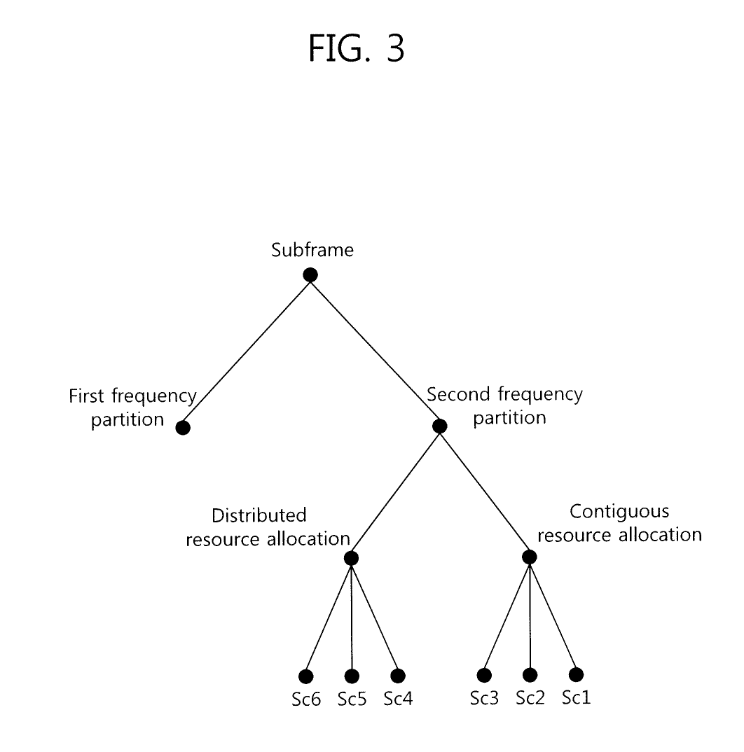

FIG. 2 shows an example of a frame structure.

Referring to FIG. 2, a superframe (SF) includes a superframe header (SFH) and four frames F0, F1, F2, and F3. Each frame may have the same length in the SF. Although it is shown that each SF has a length of 20 milliseconds (ms) and each frame has a length of 5 ms, the present invention is not limited thereto. A length of the SF, the number of frames included in the SF, the number of SFs included in the frame, or the like can change variously. The number of SFs included in the frame may change variously according to a channel bandwidth and a cyclic prefix (CP) length.

One frame includes 8 subframes SF0, SF1, SF2, SF3, SF4, SF5, SF6, and SF7. Each subframe can be used for uplink or downlink transmission. One subframe includes a plurality of orthogonal frequency division multiplexing (OFDM) symbols in a time domain, and includes a plurality of subcarriers in a frequency domain. An OFDM symbol is for representing one symbol period, and can be referred to as other terminologies such as an OFDM symbol, an SC-FDMA symbol, etc., according to a multiple access scheme. The subframe can consist of 5, 6, 7, or 9 OFDM symbols. However, this is for exemplary purposes only, and thus the number of OFDM symbols included in the subframe is not limited thereto. The number of OFDM symbols included in the subframe may change variously according to a channel bandwidth and a CP length. A subframe type may be defined according to the number of OFDM symbols included in the subframe. For example, it can be defined such that a type-1 subframe includes 6 OFDM symbols, a type-2 subframe includes 7 OFDM symbols, a type-3 subframe includes 5 OFDM symbols, and a type-4 subframe includes 9 OFDM symbols. One frame may include subframes each having the same type. Alternatively, one frame may include subframes each having a different type. That is, the number of OFDM symbols included in each subframe may be identical or different in one frame. Alternatively, the number of OFDM symbols included in at least one subframe of one frame may be different from the number of OFDM symbols of the remaining subframes of the frame.

Time division duplex (TDD) or frequency division duplex (FDD) may be applied to the frame. In the TDD, each subframe is used in uplink or downlink transmission at the same frequency and at a different time. That is, subframes included in a TDD frame are divided into an uplink subframe and a downlink subframe in the time domain. In the FDD, each subframe is used in uplink or downlink transmission at the same time and at a different frequency. That is, subframes included in an FDD frame are divided into an uplink subframe and a downlink subframe in the frequency domain. Uplink transmission and downlink transmission occupy different frequency bands and can be simultaneously performed.

A subframe includes a plurality of physical resource units (PRUs) in the frequency domain. The PRU is a basic physical unit for resource allocation, and consists of a plurality of consecutive OFDM symbols in the time domain and a plurality of consecutive subcarriers in the frequency domain. The number of OFDM symbols included in the PRU may be equal to the number of OFDM symbols included in one subframe. Therefore, the number of OFDM symbols in the PRU can be determined according to a subframe type. For example, when one subframe consists of 6 OFDM symbols, the PRU may be defined with 18 subcarriers and 6 OFDM symbols.

A logical resource unit (LRU) is a basic logical unit for distributed resource allocation and contiguous resource allocation. The LRU is defined with a plurality of OFDM symbols and a plurality of subcarriers, and includes pilots used in the PRU. Therefore, a desired number of subcarriers for one LRU depends on the number of allocated pilots.

A distributed logical resource unit (DLRU) may be used to obtain a frequency diversity gain. The DLRU includes a subcarrier group distributed in a resource region in one frequency partition. The DRU has the same size as the PRU. A minimum unit for consisting the DLRU may be a tile.

A contiguous logical resource unit (CLRU) may be used to obtain a frequency selective scheduling gain. The CLRU includes a subcarrier group contiguous in a resource region. The CLRU has the same size as the PRU.

FIG. 3 shows an example of an uplink resource structure.

Referring to FIG. 3, an uplink subframe can be divided into at least one FP. Herein, the subframe is divided into two FPs (i.e., FP1 and FP2) for example. However, the number of FPs in the subframe is not limited thereto. The number of FPs can be 4 at most. Each FP can be used for other purposes such as FFR.

Each FP consists of at least one PRU. Each FP may include distributed resource allocation and/or contiguous resource allocation. Herein, the second FP (i.e., FP2) includes the distributed resource allocation and the contiguous resource allocation. ‘Sc’ denotes a subcarrier.

Hereafter, a control channel used for transmitting a control signal or a feedback signal is described. The control channel may be used for transmission of various kinds of control signals for communication between a base station and a user equipment. The control channel described below may be applied to an uplink control channel and a downlink control channel.

The control channel is designed by taking the following points into consideration.

(1) A plurality of tiles included in a control channel can be distributed over the time domain or the frequency domain in order to obtain a frequency diversity gain. For example, assuming that a DRU includes three tiles each including six consecutive subcarriers on six OFDM symbols, the control channel includes the three tiles, and each of the tiles can be distributed over the frequency domain or the time domain. In some embodiments, the control channel can include at least one tile including a plurality of mini-tiles, and the plurality of mini-tiles can be distributed over the frequency domain or the time domain. For example, the mini-tile can consist of (OFDM symbols x subcarriers)=6×6, 3×6, 2×6, 1×6, 6×3, 6×2, 6×1 or the like. Assuming that a control channel, including (OFDM symbols x subcarriers) of IEEE 802.16e=the tiles of a 3×4 PUSC structure, and a control channel, including mini-tiles, are multiplexed through a Frequency Division Multiplexing (FDM) method, the mini-tiles can consist of (OFDM symbols x subcarriers)=6×2, 6×1, etc. When taking only the control channel, including the mini-tiles, into consideration, the mini-tiles can consist of (OFDM symbols x subcarriers)=6×2, 3×6, 2×6, 1×6 or the like.

(2) To support a high-speed mobile station, the number of OFDM symbols constituting a control channel must be a minimum. For example, in order to support a mobile station moving at the speed of 350 km/h, the number of OFDM symbols constituting a control channel is properly 3 or less.

(3) The transmission power of a mobile station per symbol is limited. To increase the transmission power of a mobile station per symbol, it is advantageous to increase the number of OFDM symbols constituting a control channel. Accordingly, a proper number of OFDM symbols has to be determined with consideration taken of (2) a high-speed mobile station and (3) the transmission power of a mobile station per symbol.

(4) For coherent detection, pilot subcarriers for channel estimation have to be uniformly distributed over the time domain or the frequency domain. The coherent detection method is used to perform channel estimation using a pilot and then find data loaded on data subcarriers. For the power boosting of pilot subcarriers, the number of pilots per OFDM symbol of a control channel has to be identical in order to maintain the same transmission power per symbol.

(5) For non-coherent detection, a control signal has to consist of orthogonal codes/sequences or semi-orthogonal codes/sequences or has to be spread.

An uplink control channel may include a fast feedback channel (FFBCH), a hybrid automatic repeat request (HARQ) feedback channel (HFBCH), a ranging channel, a bandwidth request channel (BRCH), and so on. The FFBCH, the HFBCH, the ranging channel, the BRCH, etc. may be placed anywhere in an uplink subframe or frame.

The BRCH is a channel that requests radio resources for transmitting an uplink data or a control signal to be transmitted by a mobile station (MS). The BRCH includes resources for transmitting bandwidth request preambles and an additional quick access message to be transmitted by an MS. An MS may request a bandwidth by sending bandwidth request information to a base station (BS). The bandwidth request information is transmitted according to a contention-based random access method through the BRCH.

In general, a bandwidth request may be made through a 3-step or 5-step process. The 3-step bandwidth request process is for performing a quicker bandwidth request, and the 5-step bandwidth request process is for more stably performing a contention-based bandwidth request process. The 5-step bandwidth request process is commonly used, but the 3-step bandwidth request process may be performed when a quick bandwidth request needs to be made, if necessary. A BS or an MS may determine that the bandwidth request will be made through what bandwidth request process.

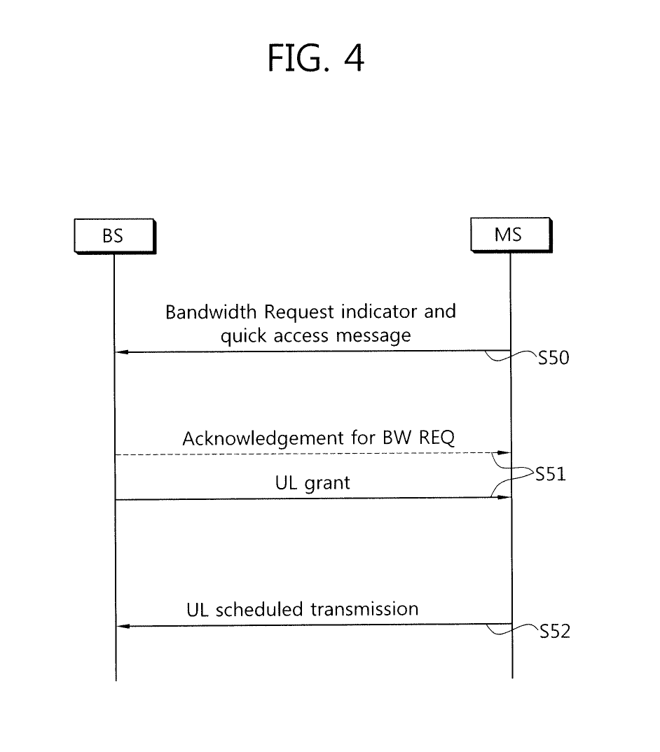

FIG. 4 is an example of the 3-step bandwidth request process. At step S50, an MS sends a bandwidth request indicator and a quick access message to a BS. The quick access message may include at least one of MS addressing, the size of a requested bandwidth, an uplink transmit power report, and a quality of service (QoS) identifier. At step S51, the BS sends an uplink (UL) grant to the MS. At this time, the BS may also send ACK meaning that the bandwidth request indicator and the quick access message have been received. At step S52, the MS performs uplink transmission. Here, information about an additional bandwidth request may be transmitted to the BS.

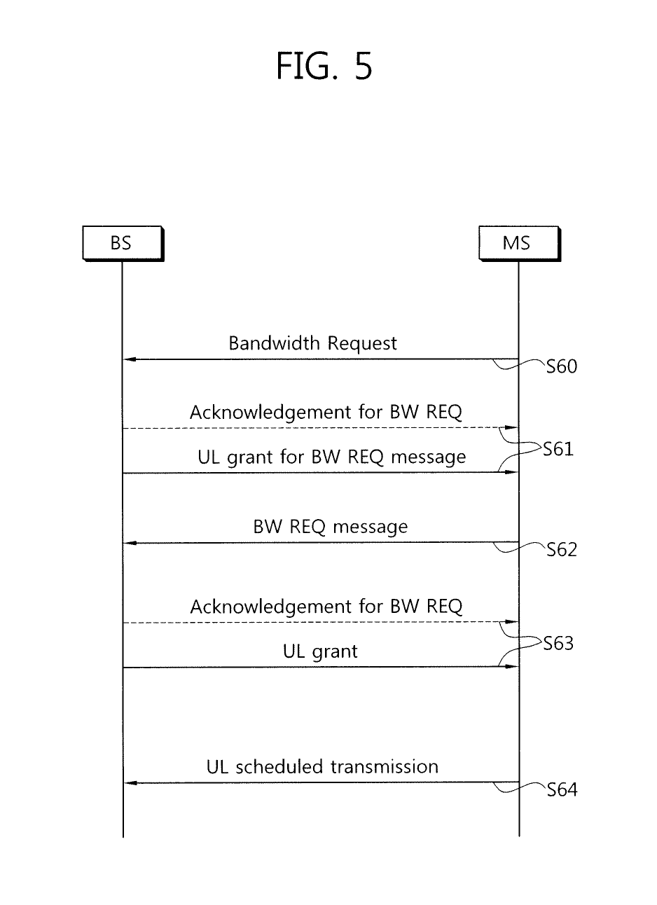

FIG. 5 is an example of the 5-step bandwidth request process.

At step S60, an MS sends a bandwidth request indicator to a BS. At step S61, the BS sends an UL grant for scheduling the transmission of a bandwidth request message to the MS. At this time, the BS may also send acknowledgement (ACK) meaning that the bandwidth request indicator has been received. At step S62, the MS sends a bandwidth request message to the BS. At step S63, the BS sends an UL grant to the MS. At this time, the BS may also send ACK meaning that the bandwidth request message has been received. At step S64, the MS performs uplink transmission. At this time, information about an additional bandwidth request may be transmitted to the BS. The above 5-step bandwidth request process may be independently performed or may be performed as an alternative bandwidth request process when the 3-step bandwidth request process of FIG. 3 is failed.

If the MS does not receive ACK for a message transmitted by the MS or the UL grant from the BS, the MS may wait until a predetermined cycle is finished and then perform the bandwidth request process again from the beginning. The predetermined cycle may be changed according to a QoS parameter, such as a scheduling type or a priority. If the bandwidth request process is performed and thus a bandwidth is immediately allocated additionally, the BS does not need to send ACK additionally.

The bandwidth request indicator may include a plurality of sequences. The plurality of sequences may be divided into a 3-step bandwidth request sequence and a 5-step bandwidth request sequence according to purposes. Information for dividing the 3-step bandwidth request sequence and the 5-step bandwidth request sequence or the index of the divided sequence may be previously designated or broadcasted. For example, if 19 sequences are given as the bandwidth request indicator, a BS may designate 17 of the 19 sequences as the 5-step bandwidth request sequence and the 2 remaining sequences as the 3-step bandwidth request sequence. Furthermore, the BS may broadcast such designation to an MS.

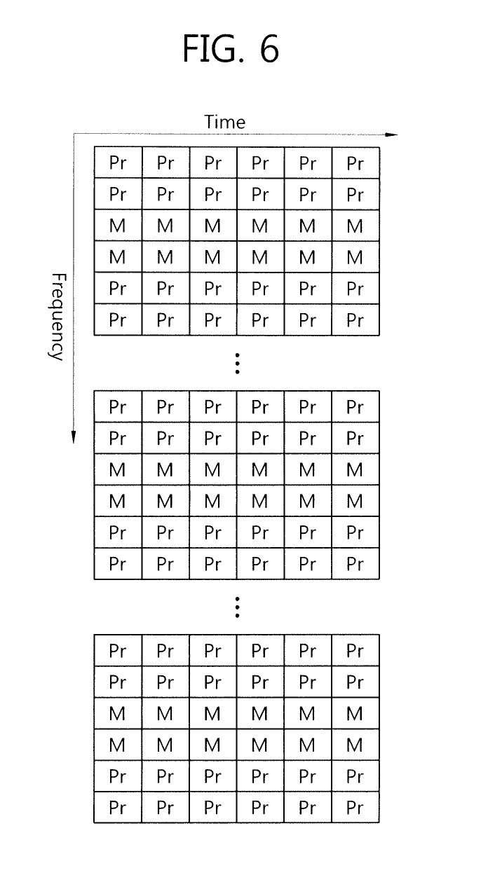

FIG. 6 shows an example of UL resources used in a BRCH.

UL resources allocated to a BRCH include at least one bandwidth request (BR) tile. The BR tile is a resource allocation unit used to send the BRCH. The BR tile may be a physical resource allocation unit or a logical resource allocation unit. One BR tile includes at least one subcarrier of the frequency domain on at least one OFDM symbol of the time domain. The BR tile includes a plurality of data subcarriers and/or pilot subcarriers. The sequence of a control signal is mapped to the data subcarrier, and a pilot for channel estimation may be mapped to the pilot subcarrier.

BR tiles 71, 72, and 73 are defined by 6 subcarriers and 6 OFDM symbols. Furthermore, each BRCH may include 3 distributed BR tiles 71, 72, and 73. That is, it means that at least one different tile may be disposed between the first BR tile 71 and the second BR tile 72 and/or between the second BR tile 72 and the third BR tile 73. Frequency diversity may be obtained by distributing and disposing the BR tiles 71, 72, and 73 in the frequency domain. The number of OFDM symbols in the time domain included in the BR tile and/or the number of subcarriers in the frequency domain are only illustrative, but not limited. The number of OFDM symbols included in the BR tile may vary according to the number of OFDM symbols included in a subframe. For example, if the number of OFDM symbols included in one subframe is 6, the number of OFDM symbols included in the BR tile may be 6.

An OFDM symbol refers to duration in the time domain, but it is not necessarily limited to a system based on OFDM/OFDMA. The OFDM symbol may be called another name, such as a symbol period, and the name called the OFDM symbol does not limit the technical spirit of the present invention to a specific multiple access scheme. Furthermore, the subcarrier refers to an allocation unit in the frequency domain. Here, one subcarrier is a unit, but a subcarrier set unit may be used.

Each of the BR tiles 71, 72, and 73 may be divided into a preamble part Pr and a data part M. The preamble part Pr may consist of 4 subcarriers and 6 OFDM symbols. The preamble part Pr sends orthogonal bandwidth request preambles.

The bandwidth request preamble may be the bandwidth request indicator of FIG. 4 or 5. The data part M may include 2 contiguous subcarriers and 6 OFDM symbols. The data part M may send information, such as the quick access message in the 3-step bandwidth request process or a station identifier (STID). The STID is information that is allocated to an MS by a BS in order to identify the MS within the region of the BS in a situation, such as network entry. The STID may have a length of 12 bits, and each MS registered with a network has an STID allocated thereto. A specific STID may be left for purposes, such as broadcast, multicast, or ranging. If the 3-step bandwidth request process is not performed, an MS may leave the data part M of the BR tile without using the data part M. That is, the data part M of the BR tile may be selectively transmitted.

A ranging channel may be used for uplink synchronization. The ranging channel may be divided into ranging channels for a non-synchronized MS and a synchronized MS. The ranging channel for a non-synchronized MS may be used for ranging for a target BS at initial network entry and during handover. An MS may not send any uplink burst or uplink control channel in a subframe in which the ranging channel for a non-synchronized MS is scheduled to be transmitted. The ranging channel for a synchronized MS may be used for periodic ranging. An MS synchronized with a target BS may send a ranging signal for a synchronized MS. The ranging channel may be allocated to one subband including 4 contiguous CLRUs.

There may be a cell having a smaller coverage than a common cell. The coverage and the transmit power of a femto cell, a relay station for relay, etc., are smaller than those of a common macro cell. A possibility that deviation of synchronization may occur between a BS and an MS is not great in a cell having a small coverage as described above. If synchronization is deviated, such deviation is not great. Accordingly, it is not necessary to robustly configure a ranging channel (in particular, an initial access ranging channel) using a lot of resources in a macro cell. Thus, the existing contention-based uplink control channel may be used for the purposes of the ranging channel.

The present invention illustrates that some or all of resources allocated to the BRCH, from a contention-based uplink control channel, are used for the purposes of an initial access ranging channel, but the present invention is not limited thereto. Some of resources allocated to another contention-based uplink control channel, from an uplink control channel, may be used for the purposes of the ranging channel.

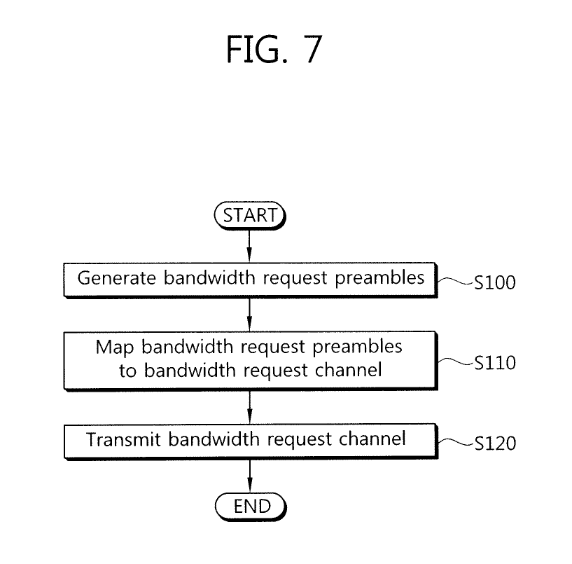

FIG. 7 is an embodiment of a proposed method for transmitting an uplink control channel.

At step S100, an MS generates a plurality of bandwidth request preambles. At step S110, the MS maps the bandwidth request preambles to a BRCH. At step S120, the MS sends the BRCH.

The bandwidth request preambles may be divided into a bandwidth request sequence for the allocation of UL resources and a ranging sequence for uplink synchronization. Since an MS performs a bandwidth request and an initial access ranging request at the same time through a BRCH, a BS needs to distinguish the bandwidth request and the initial access ranging request from each other when receiving the bandwidth request. For example, in a cell having a small coverage, such as a femto cell, UL resources may be allocated using only the 3-step bandwidth request process. Accordingly, some of bandwidth request preambles used in this case may be used for the 3-step bandwidth request process, and the remaining bandwidth request preambles may be used for ranging. Furthermore, if the bandwidth request preambles are divided into a 3-step bandwidth request sequence and a 5-step bandwidth request sequence, the 5-step bandwidth request sequence may be used for ranging. In case of initial access, an MS cannot perform a bandwidth request process because a BS has not allocated an STID to the MS. Accordingly the MS may use the 5-step bandwidth request sequence of the bandwidth request preambles for the purposes of initial access ranging. Alternatively, the MS may configure the bandwidth request preambles using a combination of the 3-step bandwidth request sequence, the 5-step bandwidth request sequence, and the ranging sequence. In addition, the bandwidth request preambles may be divided according to a service type for various purposes.

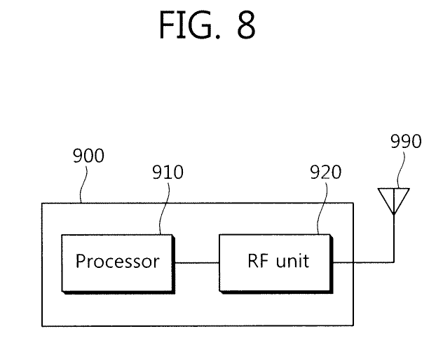

FIG. 8 is a block diagram showing of an MS in which the embodiments of the present invention are implemented.

The MS 900 includes a processor 910 and a radio frequency (RF) Unit 920. The processor 910 is coupled to the RF unit 920 and configured to generate bandwidth request preambles and map the bandwidth request preambles to a bandwidth request channel (BRCH). The RF unit 920 sends the BRCH. The bandwidth request preambles may be divided into a bandwidth request sequence for the allocation of UL resources and a ranging sequence for uplink synchronization. After the bandwidth request preambles are transmitted by the MS of FIG. 8, the bandwidth request process of FIG. 4 or 5 may be performed.

The present invention may be implemented by hardware, software, or a combination thereof. The hardware may be implemented as an application specific integrated circuit (ASIC), digital signal processing (DSP), a programmable logic device (PLD), a field programmable gate array (FPGA), a processor, a controller, a microprocessor, other electronic units, or a combination thereof, all of which is designed in order to perform the above-mentioned functions. The software may be implemented as a module performing the above-mentioned functions. The software may be stored in a memory unit and is executed by a processor. The memory unit or the processor may adopt various units that are known to those skilled in the art.

In the above-mentioned exemplary system, although the methods have described based on a flow chart as a series of steps or blocks, the present invention is not limited to a sequence of steps but any step may be generated in a different sequence or simultaneously from or with other steps as described above. Further, it may be appreciated by those skilled in the art that steps shown in a flow chart is non-exclusive and therefore, include other steps or deletes one or more steps of a flow chart without having an effect on the scope of the present invention.

The above-mentioned embodiments include examples of various aspects. Although all possible combinations showing various aspects are not described, it may be appreciated by those skilled in the art that other combinations may be made. Therefore, the present invention should be construed as including all other substitutions, alterations and modifications belong to the following claims.

What is claimed is:

1. A method for transmitting an uplink control channel in a wireless communication system, the method comprising:
generating bandwidth request preambles;
mapping the bandwidth request preambles to a bandwidth request channel (BRCH); and
transmitting the BRCH,
wherein the bandwidth request preambles comprise a ranging sequence for uplink synchronization.

2. The method of claim 1, wherein the bandwidth request preambles further include a bandwidth request sequence for an allocation of uplink resources.

3. The method of claim 2, wherein the bandwidth request sequence is divided into a 3-step bandwidth request sequence and a 5-step bandwidth request sequence.

4. The method of claim 3, wherein the 5-step bandwidth request sequence is included in the ranging sequence.

5. The method of claim 1, wherein:
the BRCH comprises 3 distributed tiles, and
each of the tiles comprises 6 subcarriers and 6 orthogonal frequency division multiplexing (OFDM) symbols.

6. The method of claim 1, wherein the bandwidth request preambles are mapped to 4 subcarriers and 6 OFDM symbols.

7. The method of claim 1, further comprising:
generating a quick access message; and
mapping the quick access message to the BRCH.

8. The method of claim 7, wherein the quick access message is mapped to 2 contiguous subcarriers and 6 OFDM symbols.

9. The method of claim 7, further comprising:
receiving an uplink (UL) grant for allocating UL resources according to the quick access message from a base station; and
performing UL transmission using the allocated UL resources.

10. The method of claim 7, wherein the quick access message comprises a station identifier (STID) used for a base station to identify a mobile station during a network entry.

11. The method of claim 1, further comprising:
receiving, from a base station, a bandwidth request message grant for allocating resources on which a bandwidth request message will be transmitted according to the bandwidth request preambles;
transmitting the bandwidth request message to the base station;
receiving an UL grant for allocating UL resources according to the bandwidth request message; and
performing UL transmission using the allocated UL resources.

12. An apparatus for transmitting an uplink control channel in a wireless communication system, the apparatus comprising:
a radio frequency (RF) unit configured for transmitting a bandwidth request channel (BRCH); and
a processor, coupled to the RF unit, and configured for:
generating bandwidth request preambles; and
mapping the bandwidth request preambles to the BRCH, and
wherein the bandwidth request preambles are divided into a bandwidth request sequence for an allocation of UL resources and a ranging sequence for uplink synchronization.

13. The apparatus of claim 12, wherein the BRCH comprises 3 distributed tiles, and each of the tiles comprises 6 subcarriers and 6 orthogonal frequency division multiplexing (OFDM) symbols.

14. The apparatus of claim 12, wherein the bandwidth request preambles are mapped to 4 subcarriers and 6 OFDM symbols.

15. The apparatus of claim 12, wherein the bandwidth request sequence is divided into a 3-step bandwidth request sequence and a 5-step bandwidth request sequence according to a bandwidth request process.
